(19) United States
(12) Patent Application Publication
(10) Pub. No.: US 2026/0004574 A1
(43) Pub. Date: Jan. 1, 2026

(54) MULTI ATTENTION SPATIO-TEMPORAL MODEL FOR FINE-GRAINED VIDEO RECOGNITION

(71) Applicant: Hamad Bin Khalifa University (HBKU), Doha (QA)

(72) Inventors: Marwa K. Qaraqe, Doha (QA); Yin Yang, Doha (QA); Elizabeth Varghese, Doha (QA); Almiqdad Elzein, Doha (QA)

(21) Appl. No.: 18/986,260

(22) Filed: Dec. 18, 2024

Related U.S. Application Data
(60) Provisional application No. 63/611,374, filed on Dec. 18, 2023.

(51) Int. Cl. G06V 10/82; G06T 3/4007; G06T 3/4046; G06V 10/44; G06V 10/77; G06V 20/40

(52) U.S. Cl. CPC G06V 10/82; G06T 3/4007; G06T 3/4046; G06V 10/44; G06V 10/7715; G06V 20/46

(57) ABSTRACT

A multi-attention spatio-temporal model for fine-grained video recognition is disclosed. This model offers a robust solution for fine-grained video recognition by addressing the intricate challenges of simultaneously considering complex spatial and temporal information, understanding temporal relationships between frames, dynamically allocating attention to informative spatial regions and temporal segments, and adapting to varying scales and resolutions. It empowers the model to not only pinpoint “where” and “when” to focus attention but also determine “how long” to make inferences, thereby enhancing overall performance. Experiments across diverse datasets demonstrate its efficiency in interpreting complex actions and scenes, enabling precise recognition. This innovation holds promise for a wide range of applications in computer vision facilitating more accurate and insightful video analysis.

### PRIORITY CLAIM AND CROSS-REFERENCE TO RELATED APPLICATIONS

The present application claims the benefit of U.S. Provisional Application No. 63/611,374 filed Dec. 18, 2023, which is incorporated herein by reference in its entirety.

### BACKGROUND

Human perception shares a crucial characteristic wherein individuals do not need to process an entire visual scene simultaneously. Instead, humans selectively focus their attention on specific parts of the visual space to gather relevant information as needed. They then integrate information from different fixations over time to construct an internal representation of the scene, which is subsequently employed for interpretation and decision-making.

In the fields of computer vision and natural language processing, attention models have demonstrated similar significance, particularly in tasks where interpretation or explanation hinges on only a small portion of an image or video. Examples include human action recognition, image recognition, visual question answering, and machine translation.

Even though these models offer a degree of interpretability by visualizing the regions they attend to for specific tasks or decisions, they often fall short when it comes to understanding the 3D spatial relationships crucial for recognizing complex actions and scenes. Therefore, there is a clear imperative for fine-grained video recognition that involves the analysis of multiple crucial regions on the screen, considering both spatial and temporal aspects.

### SUMMARY

The present disclosure provides for a multi attention spatio-temporal model for fine-grained video recognition.

According to one non-limiting aspect of the present disclosure, a multi attention spatio-temporal model for fine-grained video recognition.

According to a second non-limiting aspect of the present disclosure, an exemplary embodiment of a method of using a multi attention spatio-temporal model for fine-grained video recognition.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE DRAWINGS

FIG. 1 shows sample frames to show the need for a multi-attention spatio-temporal model for fine-grained recognition, (a) The behavior “Fighting” is at the corner of the frame, which misclassifies the frame as “Natural”, (b) The violent nature of the crowd is visible only at the periphery of the scene and classifies the scene as “Peaceful Gathering” instead of “Violent Gathering”, according to an example embodiment of the present disclosure.

FIG. 2 shows a proposed MAST model, according to an example embodiment of the present disclosure.

FIG. 3 shows visualization results of the proposed MAST model for n=2, (a)A scene of a large crowd where violence occurs only at the end of the scene, the proposed MAST correctly identifies the scene where the other models fail, (b) similar to (a), the fight scene is at the end of the video leading to the classification as a “Natural” scene instead of “Fighting” by other models except MAST, (c) a large violent gathering where violent locations can be correctly identified by MAST, according to an example embodiment of the present disclosure.

### DETAILED DESCRIPTION

The present disclosure generally relates to a multi attention spatio-temporal model for fine-grained video recognition.

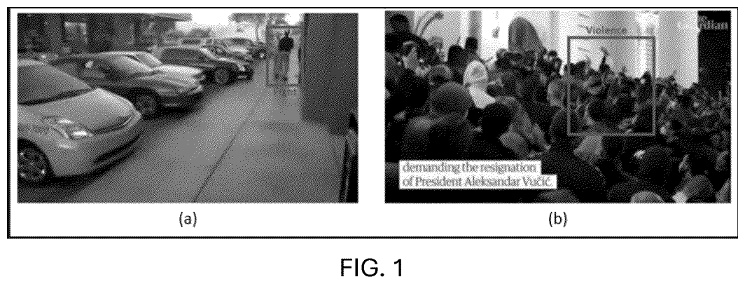

Existing models often fall short when it comes to understanding the 3D spatial relationships crucial for recognizing complex actions and scenes. For example: in FIG. 1(a), the “Fighting” behavior occurs at the corner of the frame, causing the frame to be misclassified as “Natural” while in FIG. 1(b), the violent nature of the crowd is evident only at the periphery of the scene, resulting in a misclassification of the scene as a “Peaceful Gathering” instead of a “Violent Gathering.”

For fine-grained video recognition, a well-designed attention model should focus on complex spatial and temporal information simultaneously, understand the temporal relationship between frames, dynamically allocate attention towards the most informative spatial regions and temporal segments, focus on objects or actions of interest that are partially or fully obscured, and adaptively attend to regions of varying scales and resolutions, aiding in feature extraction.

Considering all these challenges, this disclosure proposes a novel multi-attention spatio-temporal model that selects regions within the spatio-temporal domain that offer the most informative and content-rich data. Importantly, it equips the model with the capability to provide guidance on “where”, “when”, and “how long” to make inferences, enhancing its overall performance.

In the context of video recognition, the ability to visualize which specific part of each frame and which particular frame within the video sequence the model was focusing on yields invaluable insights into the model's behavior and decision-making process. Literature proposed an attention-driven Long Short-Term Memory (LSTM) that emphasizes vital spatial locations for action recognition. The literature introduced an attention mechanism, which is a combination of bottom-up and top-down attention, employing bilinear pooling techniques based on low-rank approximations. Nevertheless, these approaches primarily concentrate on identifying the critical spatial locations within individual images; they fail to consider the temporal relations that exist among different frames in a video sequence.

Literature integrated visual attention into the motion stream as a temporal attention scheme. However, the motion stream primarily relies on optical flow frames generated from consecutive frames and fails to account for long-term temporal relationships among frames within a video sequence. Additionally, the motion stream requires extra optical flow frames as input, which can impose significant overhead in terms of optical flow extraction, storage, and computation, particularly for extensive datasets. Literature proposed an attention-based LSTM model to emphasize frames within videos, but it does not consider spatial information for temporal attention. Meanwhile, an end-to-end spatial and temporal attention model was proposed for human action recognition; however, it necessitates additional skeleton data.

Recently, attention-based models were used for fine-grained recognition in both images and videos. Literature proposed a Recurrent Attention Convolutional Neural Network (RA-CNN) with an Attention Proposal Network (APN) for fine-grained image recognition. The method proposed employed Mobilenet in conjunction with a Gated Recurrent Unit (GRU) to identify patches within video frames that helps focus on relevant areas of activity. The latter is only meant for images whereas the former selects random frames ignoring the temporal property of video.

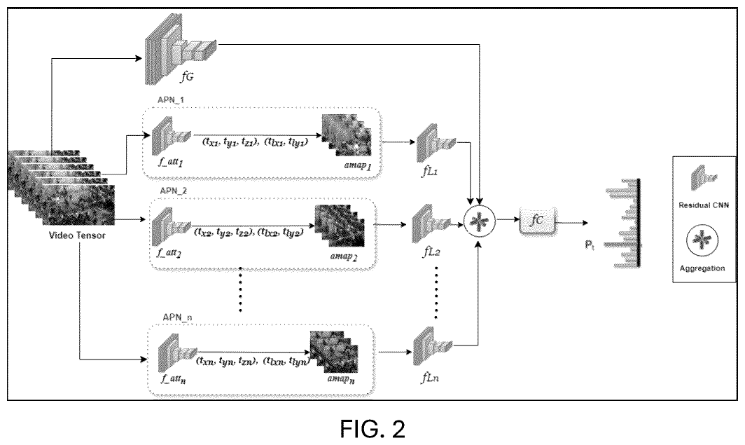

The proposed MAST model is designed to process video data. FIG. 2 shows the basic framework of the MAST model, where it takes a video tensor as input and initially takes a quick glance at each frame in the tensor using ƒ_{G} as global features. Then n Attention Proposal Networks (APNs) select the most prominent n region volumes as 3D attention maps (amap₁, amap₂, . . . , amapₙ) from the input video tensor and n ƒ_{L} extracts their local features. Finally, a classifier, ƒ_{C} takes the aggregate of the local features from all APNs with the global features to generate the prediction Pₜ.

As noted, the MAST model begins by rapidly examining each frame within the video tensor using global features denoted as ƒ_{G}. Subsequently, a set of n Attention Proposal Networks (APNs) are employed to identify the most salient regions within the video, creating 3D attention maps (amap₁, amap₂, . . . , amapₙ). These attention maps guide the extraction of local features through ƒ_{L}. Lastly, a classifier represented by ƒ_{C} combines the local features from all APNs with the global features to produce the prediction Pₜ.

Given a video surveillance scenario, in which a stream of frames is analyzed in a sequential manner and scene recognition is accomplished by simultaneously processing a set of frames in both spatial and temporal dimensions. These frames are treated as a video tensor, denoted as V_{T}, which consists of t frames represented as v₁, v₂, . . . , vₜ. each with dimensions H×W. The initial step of the proposed MAST model involves obtaining an overview of the entire video tensor V_{T} by extracting global feature maps using the function ƒ_{G}, as in equation (1).

$${g}^{f} = {f}_{G} ( {V}_{T} ) \qquad ( 1 )$$

where ƒ_{G} is a global residual convolution neural network (ResNet) having spatial and temporal modeling capability. To achieve fine-grained recognition, the Disclosed Technology introduces Attention Proposal Networks (APNs) that take the video tensor V_{T} as input and generate 3D volumes of attention maps. The Disclosed Technology employs APNs because a single attention map may not adequately capture the rich information present in various parts of the video. At the outset, the APNs take V_{T} to predict a set of coordinates of the attended region volume using attention ResNets, fatt₁, fatt₂, . . . , fattₙ. The attended region is approximated as a cuboid with given depth d and the parameters are represented as:

$$[ ( {tx}_{i} , {ty}_{i} , {tz}_{i} ) , ( {tlx}_{i} , {tly}_{i} ) ] = {fatt}_{i} ( {V}_{T} ) \qquad ( 2 )$$

where (txᵢ, tyᵢ, tzᵢ) represent the center coordinates of the i^{th} APN cuboid in terms of the x, y, and z axes, respectively, and (tlxᵢ, tlyᵢ) denotes the cuboid's length and breadth. Once the locations of the attended region volumes are hypothesized, the Disclosed Technology crops and zooms those volumes into a finer scale with higher resolution to extract more fine-grained features. The attention maps are represented as a volume and the parameterizations of the i^{th} volume are as follows:

$${x}_{{min}_{i}} = W \cdot ( {tx}_{i} - \frac{{tlx}_{i}}{2} ) + 1 , {x}_{{max}_{i}} = W \cdot ( {tx}_{i} + \frac{{tlx}_{i}}{2} ) + 1 , \qquad ( 3 )$$

$${y}_{{min}_{i}} = H \cdot ( {ty}_{i} - \frac{{tly}_{i}}{2} ) + 1 , {y}_{{max}_{i}} = H \cdot ( {ty}_{i} + \frac{{tly}_{i}}{2} ) + 1 , \qquad ( 4 )$$

$${z}_{{min}_{i}} = ( t - 2 d ) \cdot {tz}_{i} , {z}_{{max}_{i}} = ( t - 2 d ) \cdot {tz}_{i} + 2 d . \qquad ( 5 )$$

where xₘᵢₙ, xₘₐₓ, yₘᵢₙ, yₘₐₓ, zₘᵢₙ, and zₘₐₓ denote the cropped volume patch of amapᵢ from V_{T} with minimum and maximum values of the top-left, bottom-right, and depth, respectively. H and W are the height and width of V_{T}, t and d represent the number of frames in V_{T} and amapᵢ, respectively. Finally, a bilinear interpolation is performed on the cropped volume to further amplify the localized features of amapᵢ to the original frame size, H×W.

Subsequently, the local ResNets, ƒLᵢ converts the amapᵢ to feature maps,

$${l}_{i}^{f}$$

which are then aggregated with g^{ƒ} as input to the classifier ƒ_{C} to provide the predicted class Pₜ as in equations (6) and (7).

$${l}_{i}^{f} = {fL}_{i} ( Bilinear ( {amap}_{i} ) ) \qquad ( 6 )$$

$${P}_{t} = {f}_{C} ( aggregate ( {g}^{f} , {l}_{1}^{f} , {l}_{2}^{f} , … , {l}_{n}^{f} ) ) \qquad ( 7 )$$

$$where aggregate ( {g}^{f} , {l}_{1}^{f} , {l}_{2}^{f} , … , {l}_{n}^{f} ) = \frac{{g}^{f} + {l}_{1}^{f} + {l}_{2}^{f} + … + {l}_{n}^{f}}{n + 1}$$

and ƒ_{C} is a prediction network employed to combine the information from all processed frames and generate the recognition result for the input video tensor V_{T}. Finally, end-to-end training on the model was performed by minimizing the categorical cross-entropy loss.

The proposed fine-grained video recognition approach was tested on datasets containing violence and fight-related events, as it is of paramount importance to detect and respond to such events promptly in any part of a video, for enhancing security in public surveillance systems. Specifically, the Disclosed Technology utilized the publicly available benchmark datasets such as the Hockey Fight Dataset (HFD), the Violent Flows Dataset (VFD), the Surveillance Camera Fight Dataset (SCFD), and the Real Life Violence Dataset (RLVD). The HFD comprises a collection of 1,000 video sequences categorized into two distinct classes: fights and non-fights. A similar binary classification scheme is also applied to the SCFD, consisting of 300 video recordings. The VFD, on the other hand, comprises 246 video instances, each annotated to distinguish between violent and non-violent behaviors. Lastly, the RLFD encompasses a more extensive compilation featuring 2000 video clips that are segregated into the violence and non-violence categories.

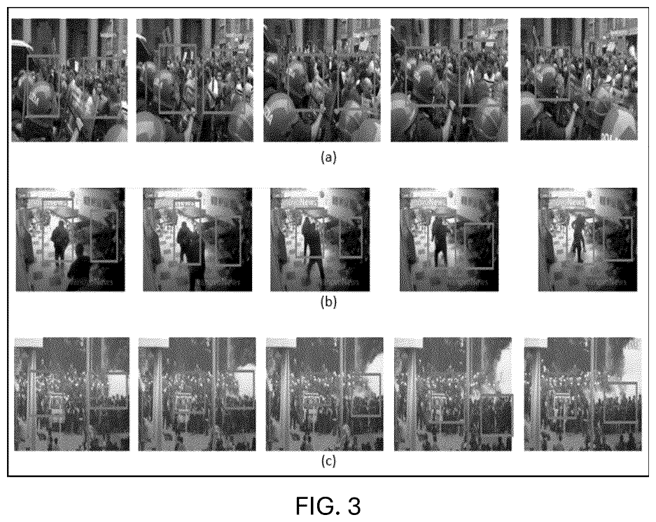

In addition, the Disclosed Technology includes the creation of a novel dataset namely Multi-Scale Violence Dataset (MSVD) that consists of diverse crowd behavior based on crowd size and violence level. The Disclosed Technology defines four crowd behavior classes that distinguish crowd behaviors based on crowd dynamics and level of violence such as Natural (N), Large Peaceful Gathering (LPG), Large Violent Gathering (LVG), and Fighting (F). LPG depicts a large number of individuals gathered for a unique purpose, like peaceful protests or sports spectators, whereas LVG represents a large group of individuals of whom a significant number are engaged in violent action that includes clashes with police, fighting between members of the crowd, property destruction, etc. On the other hand, F refers to a small group of individuals fighting each other, and if the footage shows no relation to the above-described behaviors, it is classified as N. FIG. 3 portrays the sample frames from each class, (a)A scene of a large crowd where violence occurs only at the end of the scene, the proposed MAST correctly identifies the scene where the other models fail, (b) similar to (a), the fight scene is at the end of the video leading to the classification as a “Natural” scene instead of “Fighting” by other models except MAST, (c) a large violent gathering where violent locations can be correctly identified by MAST.

For training and validation, the Disclosed Technology followed a frame-sampling strategy to create video tensors across various datasets. Specifically, each video tensor consists of a specific number of frames, with 20 frames for MSVD, SCFD, and RLFD, 16 frames for HFD, and 11 frames for VFD. To augment training data, the Disclosed Technology applied random scaling, followed by a 224×224 random cropping process. During the inference phase, the Disclosed Technology resized all frames to 256×256 and subsequently center-cropped them to a final size of 224×224. The training and validation of the proposed model were performed with a training validation ratio of 8:2. All the experiments were done using Python's PyTorch framework in NVIDIA RTX 3090Ti GPU.

The Disclosed Technology utilized the R(2+1)D architecture as the feature extractor networks, namely, ƒ_{G}, fattᵢ, and ƒ_{L}, and implemented a one-layer neural network with a sigmoid activation function for ƒ_{C}. The ƒ_{G}, fattᵢ, and ƒ_{L} networks were trained with a Stochastic Gradient Descent (SGD) optimizer, incorporating cosine learning rate annealing and a momentum value of 0.9, while the Adam optimizer was employed for ƒ_{C}. The batch size was configured as 16, and the ƒ_{G}, fattᵢ, and ƒ_{L} networks were initialized with pre-trained R(2+1)D on kinetics 400. Training was conducted for 150 epochs, starting with an initial learning rate of 0.01 and utilizing full inputs.

The performance was compared by calculating the Top-1 Accuracy of the model in different datasets and the results are given in Tables 1, 2, 3, 4, and 5. All the results were computed by employing n=2 APNs and a depth of d=4 for the proposed MAST model. The results substantiate the efficiency of the proposed approach in focusing on spatial and temporal patterns occurring in various locations associated with violent and fight scenarios. Experiments were conducted by varying the number of APNs and depth values on the MSVD dataset, and the results are presented in Table 6. The findings indicate that using two attention proposal networks with a depth of 4 allows for the recognition of a broader range of patterns compared to other configurations.

TABLE 1
Comparison of Accuracy (%) in Hockey Fight Dataset (HFD)

| Methods | Accuracy (%) |
|---|---|
| Violent Flow Descriptor (ViF) (Hassner et al., 2012) | 82.9 |
| ViF + Oriented ViF (Gao, Y. et al., 2016) | 87.5 |
| I3D-Conv Net (Carreira et al., 2018) | 93.4 |
| Three streams + LSTM (Dong et al., 2016) | 93.9 |
| MoSIFT + KDE (Xu et al., 2014) | 94.3 |
| Su et al. (Su et al., 2020) | 96.8 |
| Convolutional LSTM (Sudhakaran & Lanz, 2017) | 97.1 |
| Obregón et al. (Freire-Obreg 'on et al., 2022) | 97.4 |
| CNN + LSTM (Abdali, Al-Maamoon R. & Al-Tuma, | 98 |
| 2019) | |
| MAST | 100 |

TABLE 2
Comparison of Accuracy (%) in Surveillance
Camera Fight Dataset (SCFD)

| Methods | Accuracy (%) |
|---|---|
| VGG16 + Bi-LSTM (Akt\i\cSeymanur et al., 2019) | 52 |
| Xception CNN + LSTM (Akt\i\cSeymanur et al., 2019) | 55 |
| VGG16 + LSTM (Akt\i\cSeymanur et al., 2019) | 61.67 |
| Xception CNN + Bi-LSTM (Akt\i\cSeymanur et al., | 63 |
| 2019) | |
| Xception CNN + Bi-LSTM + Attention | 68 |
| (Akt\i\cSeymanur et al., 2019) | |
| Akti et al. (Akt\i\cSeymanur et al., 2019) | 72 |
| Ullah at al. (Ullah et al., 2021) | 75.9 |
| MAST | 91.8 |

TABLE 3
Comparison of Accuracy(%) in Real
Life Violence Dataset (RLVD)

| Methods | Accuracy (%) |
|---|---|
| CNN + LSTM (Soliman et al., 2019) | 88.8 |
| Temporal Fusion CNN + LSTM (de Oliveira Lima & | 91 |
| Figueiredo, Carlos Maur 'icio Ser 'odio, 2021) | |
| Abdali et al. (Abdali, Almamon Rasool, 2021) | 96.25 |
| MAST | 96.5 |

TABLE 4
Comparison of Accuracy (%) in Violent Flows Dataset (VFD)

| Methods | Accuracy (%) |
|---|---|
| Violent Flow Descriptor (ViF) (Hassner et al., 2012) | 81.3 |
| Xu et al. (Xu et al., 2014) | 89.05 |
| ViF + Deep Neural Network (Gao, M. et al., 2019) | 90.17 |
| 3DCNN + SVM (Varghese & Thampi, 2018) | 90.6 |
| Varghese et al. (Varghese et al., 2020) | 92.9 |
| Zhang et al. (Zhang et al., 2016) | 93.19 |
| Hachiuma et al. (Hachiuma et al., 2023) | 94.7 |
| MAST | 95 |

TABLE 5
Comparison of Accuracy(%) in Multi-
Scale Violence Dataset (MSVD)

| Methods | Accuracy (%) |
|---|---|
| AdaFocusV2 (Wang et al., 2022) | 82 |
| R(2 + 1)D (Tran et al., 2018) | 83.23 |
| ResNet3D (Tran et al., 2018) | 83.74 |
| Swin Transformer (Liu et al., 2022) | 83.9 |
| MAST | 85 |

TABLE 6
Comparison of Accuracy(%) for multiple APNs (n) and
depth (d) values using different models in MSVD

| f_{G}, fattᵢ, fLᵢ | n | d | Accuracy (%) |
|---|---|---|---|
| ResNet3D | 2 | 4 | 82 |
| | 3 | 4 | 81 |
| | 3 | 8 | 70 |
| R(2 + 1)D | 2 | 4 | 85 |
| | 3 | 4 | 82 |
| | 3 | 8 | 73 |

FIG. 3 illustrates the visualization results of the proposed MAST model, with green boxes indicating the areas of the scene where attention maps are selected by the model. The figure clearly demonstrates the model's ability to identify crucial regions within the video that aid in the correct classification of crowd behavior. These scenarios were sourced from the MSVD dataset, where fine-grained recognition is essential to distinguish various crowd behaviors. The proposed MAST model accurately identifies behaviors occurring at different locations throughout the video, including those at the video's end, showcasing its effectiveness in multi-attention fine-grained video recognition.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system for multi attention spatio-temporal model for fine-grained video recognition, comprising:
input video frames,
an overview function,
a 3D volumes of attention map function,
a local feature extraction function, and
a classifier function,
wherein the overview function is:
$${g}^{f} = {f}_{G} ( {V}_{T} ) ,$$
where the input video frames are treated as video tensor denoted by V_{T}, wherein V_{T} consists of t frames represented as v₁, v₂, . . . , vₜ, each with dimensions H×W, and wherein ƒ_{G} is a global residual convolution neural network (ResNet) having spatial and temporal modeling capability.

2. The system of claim 1, wherein the 3D volumes of attention map function introduces Attention Proposal Networks (APNs) that take the video tensor V_{T} as input and generate 3D volumes of attention maps.

3. The system of claim 2, wherein the APNs use V_{T} to predict a set of coordinates of attended region volume using attention ResNets, fatt₁, fatt₂, . . . , fattₙ, wherein the attended region is approximated as a cuboid with given depth d and the parameters are represented as:
$$[ ( {tx}_{i} , {ty}_{i} , {tz}_{i} ) , ( {tlx}_{i} , {tly}_{i} ) ] = {fatt}_{i} ( {V}_{T} ) ,$$
where (txᵢ, tyᵢ, tzᵢ) represent the center coordinates of the i^{th} APN cuboid in terms of the x, y, and z axes, respectively, and (tlxᵢ, tlyᵢ) denotes the cuboid's length and breadth.

4. The system of claim 3, wherein the cuboid's length and breadth (tlxᵢ, tlyᵢ) are cropped and zoomed into finer scale with higher resolution to extract more fine-grained features to result in attention maps.

5. The system of claim 4, wherein the attention maps are represented as a volume and the parameterizations of the i^{th} volume are as follows:
$${x}_{{min}_{i}} = W \cdot ( {tx}_{i} - \frac{{tlx}_{i}}{2} ) + 1 , {x}_{{max}_{i}} = W \cdot ( {tx}_{i} + \frac{{tlx}_{i}}{2} ) + 1 ,$$
$${y}_{{min}_{i}} = H \cdot ( {ty}_{i} - \frac{{tly}_{i}}{2} ) + 1 , {y}_{{max}_{i}} = H \cdot ( {ty}_{i} + \frac{{tly}_{i}}{2} ) + 1 ,$$
$${z}_{{min}_{i}} = ( t - 2 d ) \cdot {tz}_{i} , {z}_{{max}_{i}} = ( t - 2 d ) \cdot {tz}_{i} + 2 d ,$$
where xₘᵢₙ, xₘₐₓ, yₘᵢₙ, yₘₐₓ, zₘᵢₙ, and zₘₐₓ denote the cropped volume patch of amapᵢ from V_{T} with minimum and maximum values of the top-left, bottom-right, and depth, respectively. H and W are the height and width of V_{T}, t and d represent the number of frames in V_{T} and amapᵢ respectively.

6. The system of claim 5, wherein a bilinear interpolation is performed on the cropped volume patch of amapᵢ from V_{T} to further amplify the localized features of amapᵢ to the original frame size, H×W.

7. The system of claim 6, wherein a local ResNets, fLᵢ converts the amapᵢ to feature maps, lf which are then aggregated with g^{ƒ} as input to the classifier ƒ_{C} to provide the predicted class Pₜ in:
$${l}_{i}^{f} = {fL}_{i} ( Bilinear ( {amap}_{i} ) )$$
$${P}_{t} = {f}_{C} ( aggregate ( {g}^{f} , {l}_{1}^{f} , {l}_{2}^{f} , … , {l}_{n}^{f} ) )$$
$$where aggregate ( {g}^{f} , {l}_{1}^{f} , {l}_{2}^{f} , … , {l}_{n}^{f} ) = \frac{{g}^{f} + {l}_{1}^{f} + {l}_{2}^{f} + … + {l}_{n}^{f}}{n + 1}$$
and ƒ_{C} is a prediction network employed to combine the information from all processed frames and generate the recognition result for the input video tensor V_{T}.

8. A method of using a multi attention spatio-temporal model for fine-grained video recognition, comprising:
inputting video frames,
applying an overview function,
applying a 3D volumes of attention map function,
applying a local feature extraction function, and
applying a classifier function,
wherein the overview function is:
$${g}^{f} = {f}_{G} ( {V}_{T} ) ,$$
where the video frames are treated as video tensor denoted by V_{T}, wherein V_{T} consists of t frames represented as v₁, v₂, . . . , vₜ, each with dimensions H×W, and wherein ƒ_{G} is a global residual convolution neural network (ResNet) having spatial and temporal modeling capability.

9. The method of claim 8, wherein the 3D volumes of attention map function introduces Attention Proposal Networks (APNs) that take the video tensor V_{T} as input and generate 3D volumes of attention maps.

10. The method of claim 9, wherein the APNs use V_{T} to predict a set of coordinates of attended region volume using attention ResNets, fatt₁, fatt₂, . . . , fattₙ, wherein the attended region is approximated as a cuboid with given depth d and the parameters are represented as:
$$[ ( {tx}_{i} , {ty}_{i} , {tz}_{i} ) , ( {tlx}_{i} , {tly}_{i} ) ] = {fatt}_{i} ( {V}_{T} ) ,$$
where (txᵢ, tyᵢ, tzᵢ) represent the center coordinates of the i^{th} APN cuboid in terms of the x, y, and z axes, respectively, and (tlxᵢ, tlyᵢ) denotes the cuboid's length and breadth.

11. The method of claim 10, wherein the cuboid's length and breadth (tlxᵢ, tlyᵢ) are cropped and zoomed into finer scale with higher resolution to extract more fine-grained features to result in attention maps.

12. The method of claim 11, wherein the attention maps are represented as a volume and the parameterizations of the i^{th} volume are as follows:
$${x}_{{min}_{i}} = W \cdot ( {tx}_{i} - \frac{{tlx}_{i}}{2} ) + 1 , {x}_{{max}_{i}} = W \cdot ( {tx}_{i} + \frac{{tlx}_{i}}{2} ) + 1 ,$$
$${y}_{{min}_{i}} = H \cdot ( {ty}_{i} - \frac{{tly}_{i}}{2} ) + 1 , {y}_{{max}_{i}} = H \cdot ( {ty}_{i} + \frac{{tly}_{i}}{2} ) + 1 ,$$
$${z}_{{min}_{i}} = ( t - 2 d ) \cdot {tz}_{i} , {z}_{{max}_{i}} = ( t - 2 d ) \cdot {tz}_{i} + 2 d ,$$
where xₘᵢₙ, xₘₐₓ, yₘᵢₙ, yₘₐₓ, zₘᵢₙ, and zₘₐₓ denote the cropped volume patch of amapᵢ from V_{T} with minimum and maximum values of the top-left, bottom-right, and depth, respectively. H and W are the height and width of V_{T}, t and d represent the number of frames in V_{T} and amapᵢ, respectively.

13. The method of claim 12, wherein a bilinear interpolation is performed on the cropped volume patch of amapᵢ from V_{T} to further amplify the localized features of amapᵢ to the original frame size, H×W.

14. The method of claim 13, wherein a local ResNets, fLᵢ converts the amapᵢ to feature maps, lf which are then aggregated with g^{ƒ} as input to the classifier ƒ_{C} to provide the predicted class Pₜ in:
$${l}_{i}^{f} = {fL}_{i} ( Bilinear ( {amap}_{i} ) )$$
$${P}_{t} = {f}_{C} ( aggregate ( {g}^{f} , {l}_{1}^{f} , {l}_{2}^{f} , … , {l}_{n}^{f} ) )$$
$$where aggregate ( {g}^{f} , {l}_{1}^{f} , {l}_{2}^{f} , … , {l}_{n}^{f} ) = \frac{{g}^{f} + {l}_{1}^{f} + {l}_{2}^{f} + … + {l}_{n}^{f}}{n + 1}$$
and ƒ_{C} is a prediction network employed to combine the information from all processed frames and generate the recognition result for the input video tensor V_{T}.

15. A model for multi attention spatio-temporal model for fine-grained video recognition, comprising:
an overview function,
a 3D volumes of attention map function,
a local feature extraction function, and
a classifier function,
wherein the overview function is:
$${g}^{f} = {f}_{G} ( {V}_{T} ) ,$$
where input video frames are treated as video tensor denoted by V_{T}, wherein V_{T} consists of t frames represented as v₁, V₂, . . . , vₜ, each with dimensions H×W, and wherein ƒ_{G} is a global residual convolution neural network (ResNet) having spatial and temporal modeling capability.

16. The model of claim 15, wherein the 3D volumes of attention map function introduces Attention Proposal Networks (APNs) that take the video tensor V_{T} as input and generate 3D volumes of attention maps, and wherein the APNs use V_{T} to predict a set of coordinates of attended region volume using attention ResNets, fatt₁, fatt₂, . . . , fattₙ, wherein the attended region is approximated as a cuboid with given depth d and the parameters are represented as:
$$[ ( {tx}_{i} , {ty}_{i} , {tz}_{i} ) , ( {tlx}_{i} , {tly}_{i} ) ] = {fatt}_{i} ( {V}_{T} ) ,$$
where (txᵢ, tyᵢ, tzᵢ) represent the center coordinates of the i^{th} APN cuboid in terms of the x, y, and z axes, respectively, and (tlxᵢ, tlyᵢ) denotes the cuboid's length and breadth.

17. The model of claim 16, wherein the cuboid's length and breadth (tlxᵢ, tlyᵢ) are cropped and zoomed into finer scale with higher resolution to extract more fine-grained features to result in attention maps.

18. The model of claim 17, wherein the attention maps are represented as a volume and the parameterizations of the i^{th} volume are as follows:
$${x}_{{min}_{i}} = W \cdot ( {tx}_{i} - \frac{{tlx}_{i}}{2} ) + 1 , {x}_{{max}_{i}} = W \cdot ( {tx}_{i} + \frac{{tlx}_{i}}{2} ) + 1 ,$$
$${y}_{{min}_{i}} = H \cdot ( {ty}_{i} - \frac{{tly}_{i}}{2} ) + 1 , {y}_{{max}_{i}} = H \cdot ( {ty}_{i} + \frac{{tly}_{i}}{2} ) + 1 ,$$
$${z}_{{min}_{i}} = ( t - 2 d ) \cdot {tz}_{i} , {z}_{{max}_{i}} = ( t - 2 d ) \cdot {tz}_{i} + 2 d ,$$
where xₘᵢₙ, xₘₐₓ, yₘᵢₙ, yₘₐₓ, zₘᵢₙ, and zₘₐₓ denote the cropped volume patch of amapᵢ from V_{T} with minimum and maximum values of the top-left, bottom-right, and depth, respectively. H and W are the height and width of V_{T}, t and d represent the number of frames in V_{T} and amapᵢ, respectively.

19. The model of claim 18, wherein a bilinear interpolation is performed on the cropped volume patch of amapᵢ from V_{T} to further amplify the localized features of amapᵢ to the original frame size, H×W.

20. The model of claim 19, wherein a local ResNets, fLᵢ converts the amapᵢ to feature maps, lf which are then aggregated with g^{ƒ} as input to the classifier ƒ_{C} to provide the predicted class Pₜ in:
$${l}_{i}^{f} = {fL}_{i} ( Bilinear ( {amap}_{i} ) )$$
$${P}_{t} = {f}_{C} ( aggregate ( {g}^{f} , {l}_{1}^{f} , {l}_{2}^{f} , … , {l}_{n}^{f} ) )$$
$$where aggregate ( {g}^{f} , {l}_{1}^{f} , {l}_{2}^{f} , … , {l}_{n}^{f} ) = \frac{{g}^{f} + {l}_{1}^{f} + {l}_{2}^{f} + … + {l}_{n}^{f}}{n + 1}$$
and ƒ_{C} is a prediction network employed to combine the information from all processed frames and generate the recognition result for the input video tensor V_{T}.
